(19) United States
(12) Patent Application Publication
(10) Pub. No.: US 2006/0059085 A1
(43) Pub. Date: Mar. 16, 2006

(54) METHOD, SYSTEM, AND COMPUTER PROGRAM FOR ON-DEMAND SHORT TERM LOAN PROCESSING AND OVERDRAFT PROTECTION

(76) Inventor: Scott A. Tucker, Overland Park, KS (US)

Correspondence Address: HOVEY WILLIAMS LLP, 2405 GRAND BLVD., SUITE 400, KANSAS CITY, MO, 64108, US

(21) Appl. No.: 10/905,128

(22) Filed: Dec. 16, 2004

Related U.S. Application Data
(63) Continuation-in-part of application No. 10/711,407, filed on Sep. 16, 2004.

(51) Int. Cl. G06Q 40/00

(52) U.S. Cl. 705/38

(57) ABSTRACT

A method, system, and computer program for on-demand short term loan processing and overdraft protection is disclosed which utilizes computing equipment (10) to expedite and facilitate loan approval, overdraft protection, and the transfer of funds. The method generally includes the steps of: establishing a customer account for a customer; receiving a request for overdraft protection from the customer; utilizing computing equipment to approve the request for overdraft protection; receiving a request for funds due to a transaction initiated by the customer; utilizing computing equipment to automatically provide an overdraft protection amount when the customer account lacks sufficient funds to cover the initiated transaction; and automatically withdrawing the overdraft protection amount and an overdraft fee from the customer account when additional funds are deposited into the customer account.

### RELATED APPLICATION

The present application is a continuation in part of an earlier-filed, U.S. non-provisional patent application titled METHOD, SYSTEM, AND COMPUTER PROGRAM FOR ON-DEMAND SHORT TERM LOAN PROCESSING, application Ser. No. 10/711,407, filed Sep. 16, 2004. The present application claims priority benefit of the identified application, and hereby incorporates the identified application by reference.

### BACKGROUND OF THE INVENTION

1. Field of the Invention

The present invention relates to on-demand short term loan processing and overdraft protection. More particularly, the invention relates to a method, system, and computer program for on-demand short term loan processing and overdraft protection that enables a customer to easily receive overdraft protection on a customer account.

2. Description of the Prior Art

Individuals frequently require money on short notice for various reasons, such as to quickly repay loans or bills, for emergency situations, to purchase products, etc. One way to quickly obtain money is through payday short-term loans which customers repay on their next pay day. Such conventional short term loans generally require a customer to establish a conventional bank account by providing a substantial amount of information, such as a social security number, a state issued identification card, employment background data, and credit history. Customers are also often given the opportunity to establish a payroll account which requires the involvement of the customer's employer, which is sometimes undesirable due to privacy concerns.

Conventional short term loans also require lender approval of loan requests. For instance, a customer who is requesting a short term loan must wait a substantial amount of time while the lender, or an agent of the lender, personally approves the loan. The wait time often defeats the purpose of the short term loan, as the customer generally requires immediate funds for the reasons discussed above. Expedited short term loan methods have been developed, but even these methods generally require the customer to wait a substantial amount of time to receive funds, even though a loan request was approved in an expedited manner. For instance, customers may often receive loan approval over the telephone, but must wait a substantial amount of time, such as a day or more, before they may access any loaned funds. Furthermore, the involvement of the lender in these additional conventional short term loan methods also delays the process.

Payroll loan methods have also been developed which enable a customer to receive funds in between pay days. However, payroll loan methods require the customer's employer to establish and authorize a payroll account. Thus, customers having an employer who has not established a payroll loan system may not utilize payroll loan methods. Additionally, the payroll loan methods require the customer to establish the payroll account far in advance of requesting a loan, such as by having the customer establish the payroll account at the start of employment. Thus, customers who failed to establish a payroll account at the start of their employment, or who have not established a payroll account before the current pay period, are generally unable to utilize payroll loan methods. Furthermore, the employer's involvement in the payroll loan system often enables the employer to be aware of the customer's loan request and to reject or otherwise interfere with the request. Thus, payroll loan methods often subject customers to undue embarrassment.

In other situations, short-term loans are not available to customers for various reasons. For example, if a customer tries to purchase a product with an account that lacks sufficient funds for the product, the customer's purchase will be denied and the prior availability of short-term loans has little effect on a customer who is unaware of his or her current account balance. Similarly, if a customer's deficiency in funds is only a few dollars, such as $5 or $50, it is unlikely that the customer will go through the effort of obtaining a short-term loan to cover such a small, but nevertheless inconvenient, deficiency.

### SUMMARY OF THE INVENTION

The present invention solves the above-described problems and provides a distinct advance in the art of on-demand short term loans and overdraft protection. More particularly, the invention provides a method, system and computer program for on-demand short term loan processing and overdraft protection that immediately approves a loan request utilizing computing equipment and enables a customer to easily utilize overdraft protection.

In one embodiment, the present invention concerns a method for overdraft protection to be utilized by a lender. The method includes the steps of establishing a customer account for a customer; receiving a request for overdraft protection from the customer; utilizing computing equipment to approve the request for overdraft protection; receiving a request for funds due to a transaction initiated by the customer; utilizing computing equipment to automatically provide an overdraft protection amount when the customer account lacks sufficient funds to cover the initiated transaction; and automatically withdrawing the overdraft protection amount and an overdraft fee from the customer account when additional funds are deposited into the customer account.

In another embodiment, the present invention concerns a method for overdraft protection to be utilized by a lender. The method includes the steps of establishing a customer account for a customer; storing customer account data that corresponds to usage of the customer account; receiving a request for overdraft protection from the customer; utilizing computing equipment to automatically approve the request for overdraft protection based on the stored customer account data; utilizing computing equipment to automatically determine an overdraft protection limit based on the stored customer account data; receiving a request for funds through a communications network due to a transaction initiated by the customer; utilizing computing equipment to automatically provide an overdraft protection amount when the customer account lacks sufficient funds to cover the initiated transaction and the deficiency in customer account funds does not exceed the overdraft protection limit; and automatically withdrawing the overdraft protection amount and an overdraft fee from the customer account when additional funds are deposited into the customer account.

In another embodiment, the present invention concerns a computer program comprising a combination of code segments. The computer program includes a code segment operable to receive an overdraft protection request from a customer through a communications network, a code segment operable to approve the overdraft protection request; a code segment operable to receive a request for funds through the communications network due to a transaction initiated by the customer; a code segment operable to automatically provide an overdraft protection amount when the customer account lacks sufficient funds to cover the initiated transaction; and a code segment operable to automatically withdraw the overdraft protection amount and an overdraft fee from the customer account when additional funds are deposited into the customer account.

Other aspects and advantages of the present invention will be apparent from the following detailed description of the preferred embodiments and the accompanying drawing figures.

### BRIEF DESCRIPTION OF THE DRAWING FIGURES

A preferred embodiment of the present invention is described in detail below with reference to the attached drawing figures, wherein:

FIG. 1 is a block diagram showing lender computing equipment, customer equipment, and third party equipment connected to a communications network as utilized by certain aspects of the present invention;

FIG. 2 is a block diagram of the lender computing equipment of FIG. 1 which may be used to implement certain aspects of the present invention;

FIG. 3 is a flow chart showing some of the steps performed when implementing the method and computer program of a first preferred embodiment of the present invention;

FIG. 4 is a flow chart showing some of the steps from FIG. 3 in more detail;

FIG. 5 is a flow chart showing some of the steps performed when implementing the method and computer program of a second preferred embodiment of the present invention; and

FIG. 6 is a flow chart showing some of the steps performed when utilizing overdraft protection with various embodiments of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

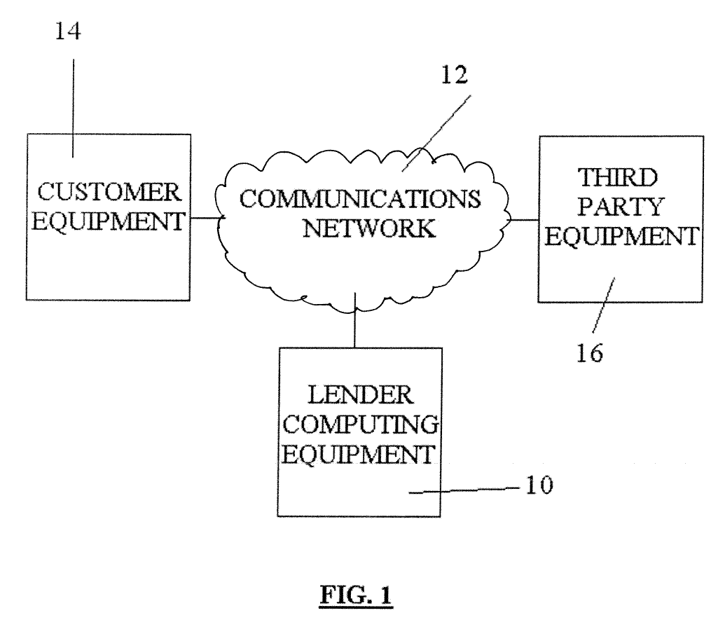

The present invention may be implemented with hardware, software, a combination thereof, or even manually, but is preferably implemented in software which controls or interfaces with lender computing equipment 10. As described below in detail and illustrated in FIG. 1, the lender computing equipment 10 is connected to a communications network 12 to enable customer equipment 14 and/or third-party equipment 16 to communicate with the lender computing equipment 10.

The equipment 10, 14 and 16, communications network 12, and a computer program illustrated and described herein are merely examples of devices and a program that may be used to implement the present invention and may be replaced with other devices and programs without departing from the scope of the present invention.

The communications network 12 may comprise a telephone network (POTS), an LAN, WAN, a wireless network, the Internet, any combination thereof, or other similar communications networks. The customers' equipment 14 and third-party equipment 16 may include conventional computing devices and/or conventional telephone devices, including personal computers, fax machines, touch-tone telephones, and cellular phones. The third-party equipment 16 may additionally include conventional banking or credit systems operated or maintained by conventional banking or credit institutions.

The lender computing equipment 10 is preferably a computing device which includes a connection element 18, a memory 20, a processor 22, an input device 24, and a transfer device 26. The computing equipment 10 may be a personal computer, a network computer running WINDOWS, NOVEL NETWARE, UNIX, LINUX, or any other network operating system, a server, a computer network comprising a plurality of computers, a mainframe or distributed computing system, a portable computing device, or any combination thereof.

The connection element 18 is operable to connect the lender computing equipment 10 to the communications network 12. The connection element 18 may be a wired or wireless connection to the communicating network to allow the lender computing equipment 10 to communicate with the customers' equipment 14, third-party equipment 16, other computers, devices, networks, customers, or additional equipment accessible through the communications network 12.

As described in more detail below, the memory 20 is computer-readable and operable to store a combination of code segments and a database. The processor 22 is operable to execute the combination of code segments and access the database. The input device 24 is operable to receive at least one input such as a loan request. The transfer device 26 is operable to deposit and withdraw funds from an account.

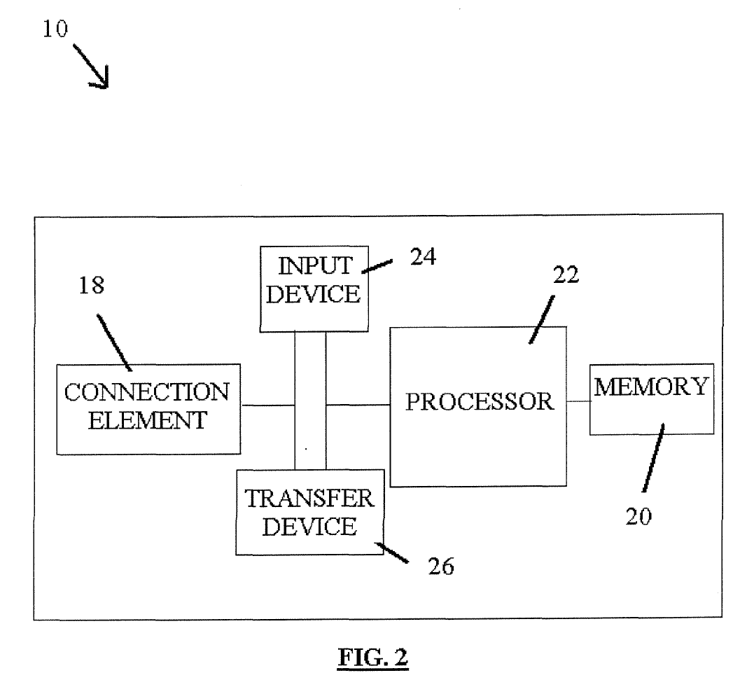

As illustrated in FIG. 2, the input device 24 and transfer device 26 may be distinct from the connection element 18, memory 20, and processor 22. However, the input device 24 and transfer device 26 may be software, hardware, firmware, or a combination thereof, and integral with, or otherwise stored within, the connection element 18, memory 20, or processor 22.

The connection element 18, memory 20, processor 22, input device 24, and transfer device 26 are interconnected with each other, such that information and data may be transferred or otherwise pass between the components of the computing equipment 10. Additionally, the connection element 18, memory 20, processor 22, input device 24, and transfer device 26 may be housed within, and/or integral with, a single unit, such as a single computing device, or be housed separately within a plurality of units. For example, the connection element 18 and input device 24 may be housed in a first computing device, and the memory 20, processor 22, and transfer device 26 may be housed in a second computing device. Furthermore, the memory 20 and processor 22 may be shared by the connection element 18, input device 24, and transfer device 26, such that the connection element 18, input device 24, and transfer device 26 are not required to include independent memory and processing elements.

The computer program described herein controls input to the equipment 10 and the operation of the equipment 10. The computer program is stored in or on the memory 20 residing on or accessible by the equipment 10 for instructing the equipment 10 and the other related components to operate as described herein. The computer program preferably comprises an ordered listing of executable instructions for implementing logical functions in the equipment 10. The computer program can be embodied in any computer-readable medium, including the memory 20, for use by or in connection with an instruction execution system, apparatus, or device, such as a computer-based system, processor-containing system, or other system that can fetch the instructions from the instruction execution system, apparatus, or device, and execute the instructions.

Preferably, the computer program includes, or is interfaced with, a web server for hosting a web-site, including at least one web page, in a substantially conventional manner, which allows the web-site to be accessed by the equipment 10 and other equipment, devices, or customers which are connected to the equipment 10 through the connection element 18. The web server, as part of the computer program, is operable to access, store, modify, or delete information stored on the equipment 10, such as information stored within the memory 20. Similarly, the connection element 18, memory 20, processor 22, input device 24, and transfer device 26 are operable to access the web server to send and receive information through the web server. The web server may include conventional web server software, such as commonly utilized APACHE or MICROSOFT products.

Additionally, the computer program preferably includes, or is interfaced with, conventional voice recognition capabilities. The voice recognition capabilities may be software, hardware, firmware, or any combination therefore. Furthermore, the voice recognition capabilities are preferably accessible or otherwise interfaced with the input device 24, as described in detail below. As is known in the art, conventional voice recognition capabilities include receiving speech, converting the received speech into a computer-readable format, and executing one or more commands based on the converted speech. The voice recognition of the present invention additionally includes an integrated voice response (IVR) which enables the voice recognition capabilities to audibly communicate with a human customer, through synthesized or pre-recorded speech, to prompt the human customer for a response or to indicate the status of a request and to allow the human customer to input information by depressing keys on a touch-tone phone. Such functionality enables the voice recognition capabilities to receive inputs from the customer through natural human speech or through touch-tone phone inputs and audibly respond to the inputs with synthesized or pre-recorded speech.

In the context of this application, a “computer-readable medium”, including the memory 20, can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, a portable compact disc (CD), a digital video disc (DVD), or a medium accessible through the connection element 18. The computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

The functionality and operation of a preferred implementation of the present invention are described below and illustrated in FIGS. 1-5. In this regard, some of the described functionality and illustrated flow diagram boxes may represent a module segment or portion of code of the computer program of the present invention which comprises one or more executable instructions for implementing the specified logical function or functions. In some alternative implementations, the functions described may occur out of the order described below. For example, functionalities described in succession may in fact be executed substantially concurrently, or the functionalities may sometimes be executed in the reverse order depending upon the functionality involved. Additionally, portions of the computer program and method may be implemented without the use of the equipment 10, as described in more detail below.

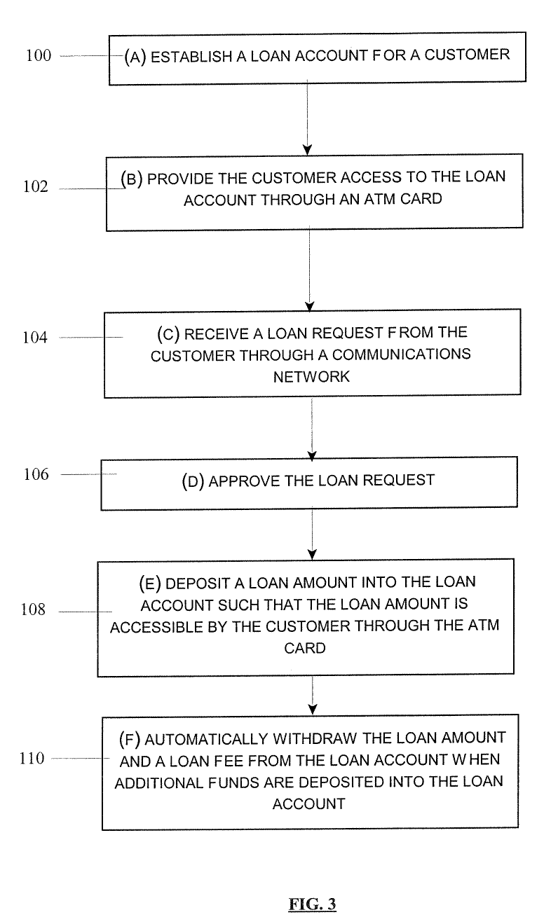

Referring to FIG. 3, the method and computer program of a first preferred embodiment of the present invention broadly includes the steps of (a) establishing a loan account for a customer, referenced at step 100 in FIG. 3; (b) providing the customer access to the loan account through an ATM card, referenced at step 102 in FIG. 3; (c) receiving a loan request from the customer through a communications network, referenced at step 104 in FIG. 3; (d) immediately approving the loan request, referenced at step 106 in FIG. 3; (e) immediately depositing a loan amount into the loan account such that the loan amount is immediately accessible by the customer through the ATM card, referenced at step 108 in FIG. 3; and (f) automatically withdrawing the loan amount and a loan fee from the loan account when additional funds are deposited into the loan account, referenced at step 110 in FIG. 3.

The lender may be a conventional lender, such as a conventional bank or a payroll service which has direct access to the customer's employment, payroll, and other similar account and financial information. However, the present invention may be utilized by unconventional lenders, other than bank or payroll services, such as by any entity regardless of the entity's ability to directly access to the customer's employment, payroll, and account information. Thus, the unconventional lenders may include private companies with no affiliation with the customer's employer or bank. As such, the customer may establish the loan account with the unconventional lender without enabling or allowing the customer's employer or bank to be aware of, or interfere with, the loan, thereby saving the customer from possible embarrassment or harassment due to the desired loan.

In connection with step 100 of FIG. 3, the loan account is preferably established for the customer before the loan request is approved. However, as described below, the loan account may be established before, during, or after the approval of the loan request. The customer's loan account is assigned an identifier, such as, for example, a number, that is specific for each customer. The loan account includes customer information, such as name, contact information, employment history, loan history, payment history, credit rating and the amount of funds available to the customer. The amount of funds available to the customer may be determined in a conventional manner, such as by utilizing the customer information, but the amount is preferably limited to $1,000 U.S. dollars. The loan account may be established through conventional means, such as by requiring the customer to speak with the lender or an agent of the lender through the telephone or in person. Preferably, the loan account is established without requiring the customer to speak with the lender or another individual, by allowing the customer to establish the loan account through the computing equipment 10.

Specifically, the loan account may be established through the computing equipment 10 by having the customer equipment 14 connect to the computing equipment 10, including the input device 24, through the connection element 18. As described in more detail below, the customer may connect to the computing equipment 10 through the web site, electronic mail, telephone, and other similar modes. Upon connection, the customer is prompted for customer information, preferably comprising the customer's name, contact information including the customer's mailing address, phone number and fax number, the customer's employer name and employer contact information, and other relevant financial information. The customer information also preferably includes a signed contract indicating the customer's acceptance of loan terms, and a personal voided check, including a primary account number and a routing number, corresponding to a primary account of the customer, such as a conventional checking or savings account not associated with the loan account.

In more detail, the customer may establish the loan account with the lender through the customer equipment 14 and communications network 12 by, for example, calling the computing equipment 10 with a conventional telephone or connecting to the computing equipment 10 utilizing a computing device connected to the communications network. The needed information may be entered by the customer's speech, such that the equipment 10 recognizes the customer's speech through the voice recognition capabilities, by depressing keys on a touch-tone telephone, and/or through the customer equipment 14 over the communications network, such as by accessing the web site or by sending electronic mail or similar instant messages.

The signed contract and the personal voided check may be provided to the lender through conventional means, such as by postal mail. However, the signed contract and personal voided check are preferably provided to the lender through more expedient methods, such as by facsimile. Specifically, the equipment 10 is operable to receive the facsimile and store a digital image of the facsimile in the memory 20. The signed contract and personal voided check may also be provided to the equipment through other expedient electronic methods, such as electronic mail including an attached scanned image of the signed contract and voided check, or an electronic document electronically signed in compliance with statutes such as the Uniform Electronic Transactions Act (UETA) or the Electronic Signatures in Global and National Commerce Act (E-SIGN).

By utilizing expedient methods, such as facsimile or electronic mail, the customer is able to rapidly provide the lender with the customer information to quickly create the loan account. Any additional information needed to establish the loan account, such as the customer's credit history, may be automatically provided by the computing equipment 10 in a substantially conventional manner, such as by accessing a conventional credit database stored on the third-party equipment 16. As a result of the expedient operation of the computing equipment 10, the customer is not required to wait a substantial amount of time, such as the many hours, days or weeks of waiting encountered when opening a conventional bank account, payroll account, or line of credit, as the creation of the loan account is facilitated and expedited by the computing equipment 10. Additionally, the customer is not required to provide an excessive amount of information to establish the loan account, as the loan account may be established with substantially less information than a conventional payroll account, bank account, or other line of credit. Thus, the loan account may be established in situations where a conventional payroll account, bank account, or other line of credit may not be established due to insufficient available information.

In connection with step 102 of FIG. 3, the customer is provided access to the established loan account through an ATM card. ATM card, as used herein, includes conventional ATM cards, bank cards, debit cards, payroll cards, credit cards, or any other device which enables the customer to receive funds through established financial or banking networks at a plurality of locations or which allows the customer to purchase goods or services at retailers or other similar locations in a substantially known and conventional manner. Thus, the ATM card may include functionality similar to that of a conventional credit or debit card. Preferably, the ATM card is provided by the lender and corresponds, by indicating the loan account identifier, only to the established loan account, such that use of the ATM card is limited to receiving the loan amount, as described below, and is not operable to access or effect the customer's other accounts, including the customer's primary account or other conventional payroll and bank accounts. Thus, the ATM card is preferably lender issued and separate from the customer's other accounts, including the primary account, such that the customer's bank is not required to be involved, and thereby delay, the use of loaned funds.

The lender issued ATM card may also be immune from cancellation by third parties, such as the customer's bank, employer, or creditors, to enable the customer to use the ATM card without embarrassment or harassment from the third parties. Additionally, the ATM card may be a payroll card utilized by an employer or other entity to directly transfer funds to the customer by depositing funds on the payroll card instead of depositing funds in a conventional banking account such that the customer is not required to possess a conventional checking account or otherwise be associated with a conventional bank.

In connection with step 104 of FIG. 3, the loan request is received from the customer through the communications network 12. The loan request may be received before or after the customer has established the loan account or the loan request may be received while the user establishes the loan account. For instance, the customer may establish the loan account and make a loan request on a first date and then be provided with the ATM card on a second date once the customer information has been verified, as discussed below. Similarly, the customer may establish the loan account on a first date, receive the ATM card on a second date, and then request a loan at any time after receiving the ATM card.

The loan request may be received through conventional means, such as by requiring the customer to speak with the lender or the agent of the lender in person or on the telephone. Preferably, the loan request is received without requiring the lender or the lender's agent to speak personally with the customer by receiving the loan request utilizing the computing equipment 10 and the customer equipment 14. Specifically, the customer may connect to the equipment 10 through the connection element 18 to access the input device 24.

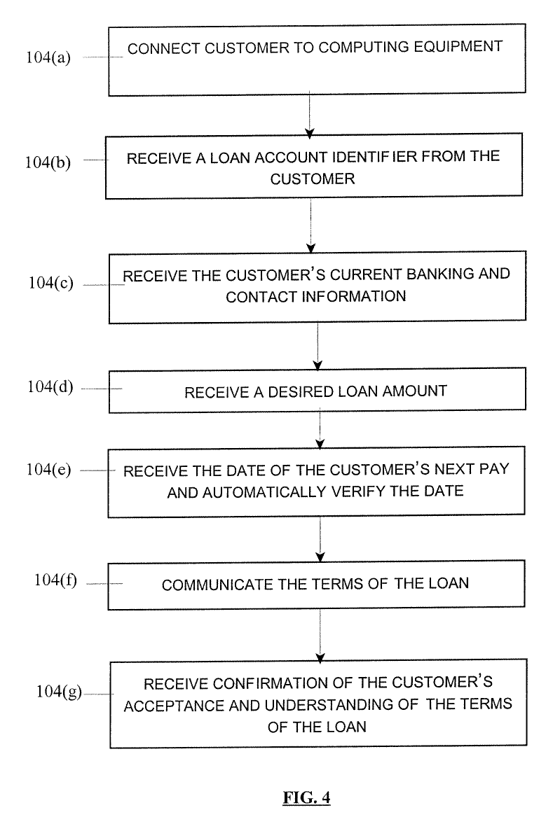

As shown in FIG. 4, the customer is prompted for loan request information upon connection to the computing equipment 10. The prompts may be text-based, such as text messages displayed on the web-site or within electronic mail, or be speech-based, such as synthetic or recorded speech generated by the voice-recognition capabilities. Customer responses to the prompts may be received by the input device 24 through the web site, electronic mail, or the voice-recognition capabilities.

The steps of the loan request illustrated in the example of FIG. 4 include the steps of: having the customer connect to the computing equipment 10, referenced at step 104(a) in FIG. 4; prompting for and receiving the customer's loan account identifier, referenced at step 104(b) in FIG. 4; prompting for and receiving the customer's current banking and contact information, referenced at step 104(c) in FIG. 4; prompting for and receiving a desired loan amount, referenced at step 104(d); in FIG. 4, prompting for and receiving the date of the customer's next pay day, referenced at step 104(e) in FIG. 4; communicating the terms of the loan, referenced as step 104(f) in FIG. 4; and prompting for and receiving conformation that the customer understands and agrees to the terms of the loan, referenced at step 104(g) in FIG. 4.

Step 104(d), prompting for and receiving the date of the customer's next pay day, may include utilizing the computing equipment 10 to automatically verify the accuracy of the customer's pay day. For instance, instead of requiring customers to calculate the dates of future pay days, which may be difficult for many customers, the customer may simply provide a payment frequency, such as weekly, every other week, twice a month, monthly, etc, along with the day of the week or month of payment and/or additional information such as the date, week, or month of the next payday. Utilizing this provided information, the computing equipment 10 may accurately calculate all future pay days for the customer by accounting for weekends, holidays, and other factors that influence the customer's pay day.

The terms of the loan utilized in step 104(f) and 104(g) are determined immediately, such that the customer is not required to wait for human input or involvement, such as from the lender, to verify or provide the terms of the loan. The terms of the loan include, for example, a finance charge, an annual percentage rate (APR), a loan due date, an approved loan amount as discussed below, and a standard loan agreement and disclosure form. The terms of the loan are determined in a conventional manner, with the exception that the terms are determined immediately by the equipment 10 based on information available in the memory 20 or through the connection element 18.

In connection with step 106 of FIG. 3, the equipment 10 automatically, without requiring input or involvement by the lender, approves a loan amount or denies the loan request based on the information provided in the loan request and the loan account. For instance, if the customer has changed jobs or banks, such that the customer has no form of income or the voided personal check is no longer valid, if the loan account indicates the customer has failed to repay past loans, if the desired loan amount exceeds the amount pre-approved in the loan account, or other such commonly encountered difficulties, the request will be denied and the customer may request to speak with the lender or an agent of the lender for additional information. Otherwise, the request will be immediately approved, provided the customer agrees to the terms of the loan as discussed below, without requiring the customer to wait hours, or any other substantial amount of time, for personal approval by the lender.

“Immediately”, as used herein, may refer to an interval of time greater than zero. For instance, computing devices, including the equipment 10, may commonly require a few hundred nanoseconds to a few minutes, hours, or even up to a day, to perform an operation, depending on the complexity of the operation and the processing, memory and communication resources available to the device. Additionally, delays in communication networks may additionally increase the time required for the loan request to be approved. For instance, electronic signals transferred between devices connected to a communications network commonly require up to a few minutes to fully transfer depending on signal length. Thus, immediate approval refers to the zero delay attributed to the lack of direct human involvement, as the approval is automatic, and not to the length of time required by the equipment 10 to approve the loan request.

As discussed above, the customer is communicated the terms of the loan before approval of the loan request. Specifically, the equipment 10 verifies the terms of the loan by communicating with the customer through the web site, electronic mail, or speech generated by the voice recognition capabilities. The customer is asked to verify the approved loan amount, the amount of the finance charges, the APR, the due date of the loan, the standard loan agreement and the disclosure form, as discussed above. The customer may verify the terms by speaking utilizing the voice recognition capabilities, by using the touch-tone telephone, by selecting boxes or other indicators communicated by the web site or the electronic mail, or in any other similar manner. The full terms of the loan may be provided to the customer through electronic mail, postal mail, facsimile, or through synthesized or recorded speech over the telephone.

In connection with step 108 of FIG. 3, the approved loan amount is immediately and automatically deposited into the loan account such that the approved loan amount is immediately accessible by the customer through the ATM card. Specifically, the transfer device 26 utilizes conventional banking methods to transfer or deposit the approved loan amount in the loan account. Additionally, if the third-party equipment 16 includes a conventional banking system, the transfer device 26 may connect to the third-party equipment 16 through the communications network 12 to transfer or deposit the loan amount. As described above, it is preferable that the loan account and ATM card be maintained by the lender, such that the lender may immediately deposit the approved loan amount without any delay or interference attributed to conventional payroll accounts or banks, to enable the customer to immediately receive the approved loan amount, in the form of cash, from any ATM machine or other similarly situated device, service, institution, or location. As described above, “immediately” as used herein refers to the lack of delay attributed to human or lender involvement in the automatic approval and deposit, and not to the time required by the equipment 10, transfer device 26 and communications network to process and transmit the deposit into the loan account.

In connection with step 110 of FIG. 3, the approved loan amount and a loan fee are automatically withdrawn from the loan account when additional funds are deposited into the loan account. Specifically, the transfer device 26 utilizes conventional banking methods to withdraw the approved loan amount and the loan fee from the loan account when additional funds are deposited into the loan account. Additionally, the transfer device 26 may connect to the third-party equipment 16, as described above, to withdraw the funds. The deposit of additional funds into the loan account may be monitored through conventional means. Preferably, as described above, the loan account is maintained and issued by the lender, such that the lender has continuous access and control of the account, and may continuously monitor deposits and withdrawals. For instance, the computing equipment 10, including the transfer device 26, may monitor the loan account and detect when the customer deposits funds into the loan account, and withdraw the loan amount and loan fee accordingly. Similarly, the equipment 10, including the transfer device 26, may monitor the loan account on the customer's next pay day, and all dates subsequent too, and withdraw the loan amount and loan fee immediately upon deposit of the additional funds.

In situations where the lender does not have direct control over the loan account, or in situations in which the customer has not deposited funds into the loan account, the voided personal check, provided by the customer to establish the loan account, may be utilized by the transfer device 26 to withdraw funds on the date of the customer's next payday, as provided in the loan request, such that the customer's paycheck provides the needed funds. Specifically, the primary account number and routing number of the voided check are stored in the memory 20, and may be utilized in an automated manner by the transfer device 26 to conventionally withdraw funds from the primary account.

The loan fee is determined in a conventional manner, and includes interest on the deposited loan amount, processing and handling fees, and any other conventional lender fees. Preferably, the loan fee is automatically determined by the computing equipment 10 based on the loan amount, the agreed upon loan terms, the time required by the customer to repay the loan, and any other conventional lender fees. Thus, the loan fee may be dynamic such that the loan fee varies based on the date on which the customer repays the loan.

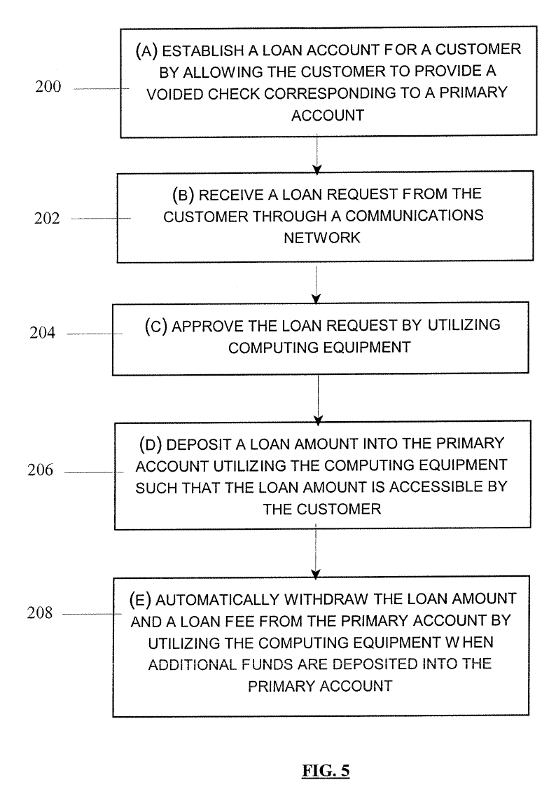

Referring to FIG. 5, the method and computer program of a second preferred embodiment of the present invention for short term loan processing to be utilized by a lender broadly includes the steps of: (a) establishing a loan account for a customer by allowing the customer to provide a voided check corresponding to a primary account, referenced at step 200 in FIG. 5; (b) receiving a loan request from the customer through a communications network, referenced at step 202 in FIG. 5; (c) approving the loan request immediately by utilizing computing equipment, referenced at step 204 in FIG. 5; (d) automatically depositing a loan amount into the primary account utilizing the computing equipment such that the loan amount is accessible by the customer, referenced at step 206 in FIG. 5; and (e) automatically withdrawing the loan amount and a loan fee from the primary account by utilizing the computing equipment when additional funds are deposited into the primary account, referenced at step 208 in FIG. 5.

The primary account may be an account maintained by the lender which is separate from the loan account, an account which corresponds to the loan account such as a payroll account, or an account maintained by a party other than the lender, such as a conventional bank account. Thus, the lender, as described above in detail, may be a conventional lender which has direct access to the customer's employment, payroll, and similar primary account and financial information. However, the present invention may be utilized by unconventional lenders, other than bank or payroll services, such as by any entity regardless of the entity's ability to directly access to the customer's employment, payroll, and account information.

Step 200 of FIG. 5 is substantially similar to step 100 of FIG. 3 as the computing equipment 10 is preferably utilized to establish the loan account in an expedient manner, with the exception that the voided check, including a primary account number and a routing number, corresponding to a primary account, must be provided by the customer before the loan account is established unless the primary account is maintained or operated by the lender.

Steps 202 and 204 of FIG. 5 are substantially similar to steps 102 and 104 of FIG. 3 as the computing equipment 10 is preferably utilized to receive the loan request, including a desired loan amount, from the customer and immediately approve the loan request and an approved loan amount. However, as described in steps 102 and 104 of FIG. 3, the loan request may be received and approved in a conventional manner, such as by the lender personally.

In connection with step 206 of FIG. 5, the approved loan amount is automatically deposited into the primary account by utilizing the computing equipment 10. Specifically, the transfer device 26 utilizes conventional banking methods to transfer or deposit the approved loan amount in the primary account. Additionally, if the third-party equipment 16 includes a conventional banking system, the transfer device 26 may connect to the third-party equipment 16 through the communications network 12 to transfer or deposit the loan amount. Preferably, the transfer device 26 immediately deposits the approved loan amount into the primary account. It will be appreciated that conventional banks often impose a delay, commonly twelve hours or twenty-four hours, before deposits are accessible by customers. Therefore, if the primary account is a conventional bank account which is not maintained by the lender, such as a conventional checking account or a savings account, the customer may be unable to immediately access the funds even if the transfer device 26 immediately deposited the approved loan amount into the primary account. However, if the primary account is maintained by the lender, the lender preferably allows the customer to immediately withdraw the approved loan amount.

In connection with step 208 of FIG. 5, the approved loan amount and a loan fee are automatically withdrawn from the primary account when additional funds are deposited into the primary account. Specifically, the transfer device 26 utilizes conventional banking methods to withdraw the approved loan amount and the loan fee from the primary account when additional funds are deposited into the primary account. Additionally, the transfer device 26 may connect to the third-party equipment 16, as described above, to withdraw the funds. The deposit of additional funds into the primary account may be monitored through conventional means. When the primary account is maintained and issued by the lender, such that the lender has continuous access and control of the account, the lender may continuously monitor deposits and withdrawals. For instance, the equipment 10, including the transfer device 26, may monitor the primary account and detect when the customer deposits funds into the primary account, and withdraw the approved loan amount and loan fee accordingly. Similarly, the equipment 10, including the transfer device 26, may monitor the primary account on the customer's next pay day, and all dates subsequent too, and withdraw the approved loan amount and loan fee immediately upon deposit of the additional funds.

In situations where the lender does not have direct control over the primary account, such as when the primary account is maintained by a conventional bank, the voided personal check, provided by the customer to establish the loan account, is utilized by the transfer device 26 to withdraw funds on the date of the customer's next payday, as provided in the loan request, such that the customer's paycheck provides the needed funds. Specifically, the primary account number and routing number of the voided check are stored in the memory 20, and may be utilized in a conventional and automated manner by the transfer device 26 to withdraw funds from the primary account. The loan fee utilized in step 208 of FIG. 5 is substantially similar to the loan fee utilized in step 110 of FIG. 3.

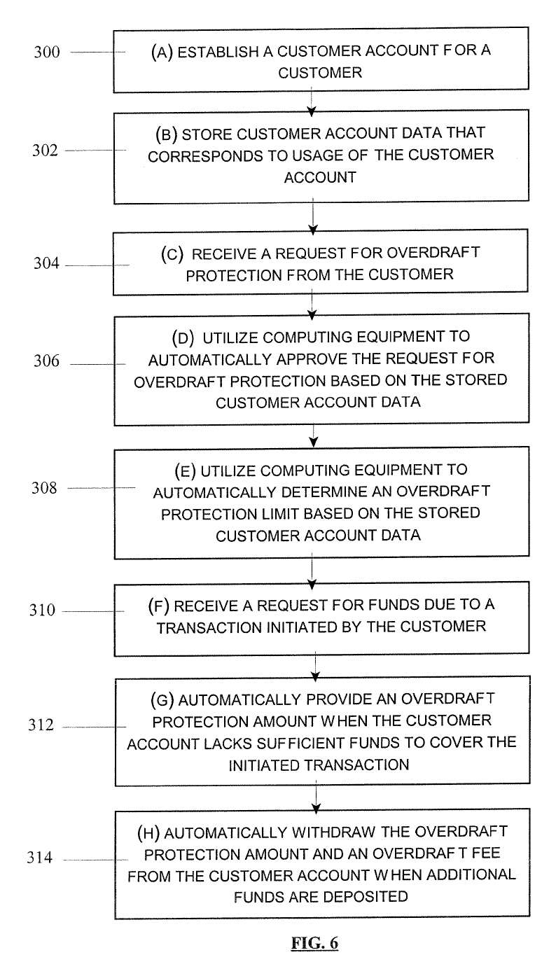

Referring to FIG. 6, the present invention may also enable the customer to receive overdraft protection instead of, or in addition to, the various loan functionality described above. Such embodiments that utilize overdraft protection may include one or more of the following steps: (a) establishing a customer account for a customer, referenced at step 300 in FIG. 6; (b) storing customer account data that corresponds to usage of the customer account, referenced at step 302 in FIG. 6; (c) receiving a request for overdraft protection from the customer, referenced at step 304 in FIG. 6; (d) utilizing computing equipment to automatically approve the request for overdraft protection such that human involvement is not required to approve the request for overdraft protection, referenced at step 306 in FIG. 6; (e) utilizing computing equipment to automatically determine an overdraft protection limit such that human involvement is not required to determine the overdraft protection limit, referenced at step 308 in FIG. 6; (f) receiving a request for funds through a communications network due to a transaction initiated by the customer, referenced at step 310 in FIG. 6; (g) utilizing computing equipment to automatically provide an overdraft protection amount when the customer account lacks sufficient funds to cover the initiated transaction and the deficiency in customer account funds does not exceed the overdraft protection limit, referenced at step 312 in FIG. 6; and (h) automatically withdrawing the overdraft protection amount and an overdraft fee from the customer account when additional funds are deposited into the customer account, referenced at step 314 in FIG. 6.

In step 300, the customer account is established in a generally similar manner to the establishment of the loan account of steps 100 and 200. Thus, step 300 is substantially similar to steps 100 and 200. Preferably, the customer account corresponds to the loan account, or the customer account is the same as the loan account, such that the customer may utilize both the various loan functionality described above and the overdraft protection functionality described below. Thus, the customer account may be an account established with a non-traditional lender in which a customer deposits his or her paycheck in exchange for the ability to receive short-term loans and/or overdraft protection. However, is some embodiments the customer account may be distinct from the loan account, or any other account, such that the customer account is not required to include the loan functionality described above. In such embodiments where the customer account is not, or is not associated with, the loan account, the customer account may still be created utilizing the methods described in steps 100 and 200.

During or after establishing the customer account, the lender preferably provides the customer with an ATM card that corresponds to the customer account in a generally similar manner to step 102 described above. The customer may utilize the ATM card as described above to request and receive loaned funds, or utilize the ATM card for other purposes including purchasing goods or services utilizing the overdraft functionality described below.

In step 302, the equipment stores customer account data that corresponds to usage of the account. Preferably, the customer account data is stored by the equipment 10 to correspond to all usages performed by a particular customer regarding a particular account. For example, the equipment 10 may store customer account data that includes the current and previous balances of the customer account, the number of previous and future customer pay days, the amount of each deposited customer pay check, the number of loans requested by the customer, the amount of funds loaned to the customer, the amount of funds repaid by the customer, the amount of lapsed time between when funds are loaned and when funds are repaid, the number of missed pay days, the amount of any outstanding loans, the amount of any approved loans, any information related the determination of the approved loan amount described above, the number and frequency of overdrafts, the amount of any previous overdrafts, etc.

In step 304, the equipment 10 receives a request for overdraft protection from the customer. For example, the customer may utilize the IVR, web page, or conventional methods such as by speaking with the lender, to request overdraft protection in addition to or instead of the loan functionality described above. Thus, the methods utilized by the customer to request overdraft protection are generally similar to the methods described above in steps 100-110 and 200-208. Additionally, the request for overdraft protection may be received simultaneously with the establishment of the account in step 300, such that the customer requests overdraft protection during or shortly after establishing the customer account.

In step 306, the equipment 10 automatically approves the request for overdraft protection such that human involvement is not required to approve the request for overdraft protection. Preferably, the equipment 10 utilizes the stored customer account data to automatically determine if the request for overdraft protection should be provided. For example, if the customer account data indicates that the customer regularly deposits funds into the customer account, such as funds corresponding to a paycheck, the equipment 10 may approve the request for overdraft protection. Similarly, if the customer account data indicates that the customer does not regularly make deposits or if other such negative data is present, such as if the customer has failed to repay a loan, the equipment 10 may deny the request for overdraft protection. It will be appreciated that the present invention may accommodate any lenders specific criteria for approving overdraft protection by configuring the equipment 10 to utilize various factors including those discussed above.

In embodiments where customer account data is not stored or otherwise utilized, the request for overdraft protection may be automatically approved for certain classes or types of customers, such as customers already having one or more accounts with the lender or customers who are pre-approved based upon employment, etc. Additionally, the equipment 10 may approve overdraft protection based upon customer provided data, such as the information described in steps 106 and 202, including the date of the customer's next pay day, information provided by the voided check, information regarding the customer's employment history, etc.

After the customer's request for overdraft protection has been approved, the customer preferably need not resubmit or re-request overdraft protection as approved overdraft protection will preferably exist for the customer account until termination by the lender or customer. However, in some embodiments, the equipment 10 may require the customer to resubmit a request for overdraft protection, such as when the customer's employment changes or if other such negative data is present.

In step 308, the computing equipment 10 automatically determines an overdraft protection limit such that human involvement is not required to determine the overdraft protection limit. Preferably, the equipment 10 utilizes the stored customer account data to automatically determine the overdraft protection limit. For example, if customer account data indicates that the customer has a history of payroll loads of $1000 for each pay period, the equipment 10 may automatically determine an overdraft protection limit of $800, or other similar value that corresponds to the customer account data regarding the ability of the customer to repay funds. Preferably, the overdraft protection limit does not exceed the average amount of funds deposited into the account during each pay period such that the lender is likely to be able to recover any overdraft funds on the customer's next pay day.

The overdraft protection limit preferably indicates the amount of funds available to the customer for overdraft for the period extending to the customer's next pay day as indicated in the customer account data. For example, if the overdraft protection limit is $800, the customer may utilize $800 in overdraft funds, as described below in detail, during the period extending to the customer's next pay day, and need not utilize the entire overdraft protection limit at one time. However, the overdraft protection limit may additionally or alternatively indicate the maximum overdraft limit provided for the customer for any single transaction.

Additionally, in some embodiments, the overdraft protection limit may be a fixed amount, such as $100, $500, $1000, etc, such that the equipment 10 need not consider the stored customer account data in its determination of the overdraft protection limit. Additionally, the period to which the overdraft protection limit applies may be distinct from the customer's pay period, and may instead be calender days or other measurements of time, such that the overdraft protection limit applies to transactions within the next 14 days, 30 days, etc.

The overdraft protection limit may be communicated to the customer so that the customer understands the amount of protection offered. The overdraft protection limit may be provided to the user through the IVR discussed above, through the web page, telephone, by speaking with the lender, or through any conventional means. It will be appreciated that as the equipment 10 may determine the overdraft protection limit automatically and immediately without lender input, the customer may request overdraft protection through the methods described above and then be quickly or immediately provided with the overdraft protection limit due to the automatic processing provided by the equipment 10.

In step 310, the equipment 10 receives a request for funds through the communications network 12 due to a transaction initiated by the customer. For example, the customer may attempt to purchase a good or service from a third-party utilizing the ATM card or by otherwise indicating the existence of the customer account to the third-party, such as by providing a customer account number, etc. In such a situation, the third-party utilizes conventional banking systems to debit money from the customer account in a similar manner utilized to debit money from conventional debit, credit, and payroll accounts. If the customer's account includes sufficient funds to purchase the good or service, the purchase is “approved” in a generally conventional manner. However, if an account does not include sufficient funds to purchase a good or service, the purchase would be declined by conventional systems.

In contrast, the present invention provides overdraft protection to enable the customer to purchase goods or services utilizing the customer account even when the customer account lacks sufficient funds for the purchase, as is referenced at step 312 in FIG. 6. For example, a transaction initiated by the customer will be approved even if the customer account lacks sufficient funds provided that the customer has requested and received overdraft protection as described in step 304 and if the deficiency between the purchase amount and the amount of funds in the account, plus the amount of any previous overdrafts for the current period, is less than the overdraft protection limit as described in step 306.

The overdraft protection amount, i.e. the amount of the deficiency between the purchase price and the amount of funds in the customer's account, will be recorded or otherwise stored in the customer's account such that an indication is available of the total amount of overdraft funds provided to a customer during each period. Additionally, the overdraft protection amount and the cumulative amount of overdraft funds for each period may be provided to the customer through the methods described above, such as through a web site, IVR, telephone, etc.

In step 314, the equipment 10 automatically withdraws the overdraft protection amount and an overdraft fee from the customer account when additional funds are deposited into the customer account in a substantially similar manner to steps 110 and 208 described above. For example, the equipment 10 may monitor the account for deposited funds or may automatically withdraw the overdraft protection amount and the overdraft fee from the customer account on the date of the customer's next payday.

The overdraft fee represents a fee charged by the lender for providing the overdraft functionality. The overdraft fee may be a fixed fee or the overdraft fee may be dynamic to correspond to the amount of overdraft, the time required by the customer to repay the overdraft, the number of overdrafts incurred by the customer, interest on the overdraft, and any conventional lender fees. Preferably, the overdraft fee is automatically determined by the computing equipment 10 based upon any of the factors described above. If the customer has incurred more than one overdraft protection amount during the current period, the overdraft fee may be calculated for each overdraft amount or a single overdraft fee may be applied to all overdraft protection amounts.

In embodiments where the customer account is a loan account, the customer may utilize both the loan functionality and overdraft functionality described herein. For example, if the customer desires a short-term loan, the equipment may receive a loan request from the customer through the communications network, approve the loan request immediately by utilizing computing equipment such that human involvement is not required to approve the loan request, deposit a loan amount immediately into the customer account utilizing the computing equipment such that human involvement is not required to deposit the loan amount into the customer account, and automatically withdraw the loan amount and a loan fee from the customer account by utilizing the computing equipment when additional funds are deposited into the customer account. Thus, the customer may enjoy both the benefits of short-term loan availability and overdraft protection through the customer account.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

What is claimed is:

1. A method for overdraft protection to be utilized by a lender, the method comprising the steps of:
(a) establishing a customer account for a customer;
(b) receiving a request for overdraft protection from the customer;
(c) utilizing computing equipment to automatically approve the request for overdraft protection such that human involvement is not required to approve the request for overdraft protection;
(d) receiving a request for funds through a communications network due to a transaction initiated by the customer;
(e) utilizing computing equipment to automatically provide an overdraft protection amount when the customer account lacks sufficient funds to cover the initiated transaction; and
(f) automatically withdrawing the overdraft protection amount and an overdraft fee from the customer account when additional funds are deposited into the customer account.

2. The method as set forth in claim 1, wherein the customer account is established through the communications network.

3. The method as set forth in claim 2, wherein the customer account is established through a web-page.

4. The method as set forth in claim 1, wherein the lender is an unconventional lender.

5. The method as set forth in claim 1, wherein the additional funds correspond to a deposited paycheck.

6. The method as set forth in claim 1, wherein the customer account is a loan account.

7. The method as set forth in claim 6, further including the steps of:
(g) receiving a loan request from the customer through the communications network;
(h) approving the loan request immediately by utilizing computing equipment such that human involvement is not required to approve the loan request;
(i) depositing a loan amount immediately into the customer account utilizing the computing equipment such that human involvement is not required to deposit the loan amount into the customer account; and
(j) automatically withdrawing the loan amount and a loan fee from the customer account by utilizing the computing equipment when additional funds are deposited into the customer account.

8. The method as set forth in claim 1, further including the step of utilizing computing equipment to automatically determine an overdraft protection limit such that human involvement is not required to determine the overdraft protection limit.

9. The method as set forth in claim 8, wherein the computing equipment automatically determines the overdraft protection limit by utilizing stored customer account data.

10. The method as set forth in claim 1, wherein the computing equipment utilizes stored customer account data to automatically approve the overdraft protection request.

11. A method for overdraft protection to be utilized by a lender, the method comprising the steps of:
(a) establishing a customer account for a customer;
(b) storing customer account data that corresponds to usage of the customer account;
(c) receiving a request for overdraft protection from the customer;
(d) utilizing computing equipment to automatically approve the request for overdraft protection based on the stored customer account data such that human involvement is not required to approve the request for overdraft protection;
(e) utilizing computing equipment to automatically determine an overdraft protection limit based on the stored customer account data such that human involvement is not required to determine the overdraft protection limit;
(f) receiving a request for funds through a communications network due to a transaction initiated by the customer;
(g) utilizing computing equipment to automatically provide an overdraft protection amount when the customer account lacks sufficient funds to cover the initiated transaction and the deficiency in customer account funds does not exceed the overdraft protection limit; and
(h) automatically withdrawing the overdraft protection amount and an overdraft fee from the customer account when additional funds are deposited into the customer account.

12. The method as set forth in claim 11, wherein the customer account is established through the communications network.

13. The method as set forth in claim 12, wherein the customer account is established through a web-page.

14. The method as set forth in claim 11, wherein the lender is an unconventional lender.

15. The method as set forth in claim 11, wherein the additional funds correspond to a deposited paycheck.

16. The method as set forth in claim 11, wherein the customer account is a loan account.

17. The method as set forth in claim 16, further including the steps of:
(i) receiving a loan request from the customer through the communications network;
(j) approving the loan request immediately by utilizing computing equipment such that human involvement is not required to approve the loan request;
(k) depositing a loan amount immediately into the customer account utilizing the computing equipment such that human involvement is not required to deposit the loan amount into the customer account; and
(l) automatically withdrawing the loan amount and a loan fee from the customer account by utilizing the computing equipment when additional funds are deposited into the customer account.

18. A computer program comprising a combination of code segments stored in a computer-readable memory and executable by a processor, the computer program comprising:
a code segment operable to receive an overdraft protection request from a customer through a communications network, wherein the overdraft protection request corresponds to a pre-existing customer account;
a code segment operable to approve the overdraft protection request such that human involvement is not required to approve the overdraft protection request;
a code segment operable to receive a request for funds through the communications network due to a transaction initiated by the customer;
a code segment operable to automatically provide an overdraft protection amount when the customer account lacks sufficient funds to cover the initiated transaction; and
a code segment operable to automatically withdraw the overdraft protection amount and an overdraft fee from the customer account when additional funds are deposited into the customer account.

19. The computer program set forth in claim 18, wherein the computer program includes a web-server operable to receive the overdraft protection request through the communications network.

20. The computer program set forth in claim 18, wherein the computer program includes voice-recognition capabilities operable to receive the overdraft protection request by telephone.

21. The computer program set forth in claim 18, further including a code segment operable to store customer account data that corresponds to usage of the customer account.

22. The computer program set forth in claim 21, wherein the stored customer account data is utilized to approve the overdraft protection request.

23. The computer program set forth in claim 21, further including a code segment operable to determine an overdraft protection limit based on the stored customer account data.

24. The method as set forth in claim 21, wherein the customer account is a loan account.
